(19) United States
(12) Patent Application Publication
(10) Pub. No.: US 2015/0248456 A1
(43) Pub. Date: Sep. 3, 2015

(54) SYSTEM AND METHOD FOR EXECUTING ACTIONS USING A MOBILE DEVICE

(71) Applicant: Han-Jia CAI, Kaohsiung City (TW)

(72) Inventor: Han-Jia CAI, Kaohsiung City (TW)

(21) Appl. No.: 14/633,676

(22) Filed: Feb. 27, 2015

(30) Foreign Application Priority Data
Mar. 3, 2014 (TW) 103203590

(51) Int. Cl. G06F 17/30; G06F 3/0354; G06F 3/0484; G06F 3/0488; H04L 29/08; G06F 3/0482

(52) U.S. Cl. CPC G06F 17/30424; H04L 67/10; G06F 3/0482; G06F 3/04842; G06F 3/04883; G06F 3/04886; G06F 3/03545

(57) ABSTRACT

A system for executing actions includes a database established with a plurality of reference strings and correspondence of each of the reference strings to at least one predefined action, and a mobile device communicatively coupled with the database. The mobile device includes an input unit for inputting a to-be-compared string, and a processor electrically coupled with the input unit. The processor is configured to search the database to find a string set of one or more of the reference strings that matches the to-be-compared string, and execute the at least one predefined action corresponding to the one or more of the reference strings of the string set found by the processor.

### CROSS-REFERENCE TO RELATED APPLICATION

This application claims priority of Taiwanese application no. 103203590, filed on Mar. 3, 2014.

### FIELD OF THE INVENTION

The present invention relates to a system for executing actions and a method for executing actions using a mobile device.

### BACKGROUND OF THE INVENTION

With the rapid development of mobile devices in recent years, total downloads from Apple Store or Google Play have been increasing year by year, and mobile device software (App) has become an important part of people's lives. People watch news, videos, find locations, view photos and perform search using these Apps.

Mobile device Apps having various functions provide greater convenience. However, an execution system of current mobile devices that allows users to open Apps is becoming increasingly complicated. For instance, a list has to be first opened before a desired App can be selected, and different models of mobile devices have different ways of launching Apps, which are not that intuitive, leading to difficulty in launching a desired App. An existing activation system manages Apps using folders or lists, helping users to categorize their Apps. However, when there are many Apps, even such categorizing does not enable one to quickly and conveniently find a desired App.

### SUMMARY OF THE INVENTION

The object of the present invention is to provide a system for executing actions that can allow users to conveniently launch a desired App or perform a predefined action by simply inputting a handwriting, voice, etc.

According to one aspect of the present invention, there is provided a system for executing actions. The system comprises:

a database established with a plurality of reference strings and correspondence of each of the reference strings to at least one predefined action; and

a mobile device communicatively coupled with the database, the mobile device including an input unit for inputting a to-be-compared string, and a processor electrically coupled with the input unit;

wherein the processor is configured to
search the database to find a string set of one or more of the reference strings that matches the to-be-compared string, and
execute the at least one predefined action corresponding to the one or more of the reference strings of the string set found by the processor.

Another object of the present invention is to provide a method for executing actions using a mobile device. The method comprises:

a) establishing, in a database, a plurality of reference strings and correspondence of each of the reference strings to at least one predefined action;

b) inputting, using the mobile device, a to-be-compared string;

c) searching, using the mobile device, the database to find a string set of one or more of the reference strings that matches the to-be-compared string; and

d) executing, using the mobile device, the at least one predefined action corresponding to the one or more of the reference strings of the string set found in step c).

### BRIEF DESCRIPTION OF THE DRAWINGS

Other features and advantages of the present invention will become apparent in the following detailed description of the embodiments with reference to the accompanying drawings, of which:

FIG. 1 is a schematic block diagram illustrating a first embodiment of a system for executing actions according to the present invention;

FIG. 2 is a schematic diagram illustrating a mobile device in the first embodiment of the system for executing actions according to the present invention;

FIG. 3 is a schematic diagram illustrating a list element for displaying a string set on the mobile device in the first embodiment of the system for executing actions according to the present invention; and

FIG. 4 is a schematic block diagram illustrating a second embodiment of the system for executing actions according to the present invention.

### DETAILED DESCRIPTION OF THE EMBODIMENTS

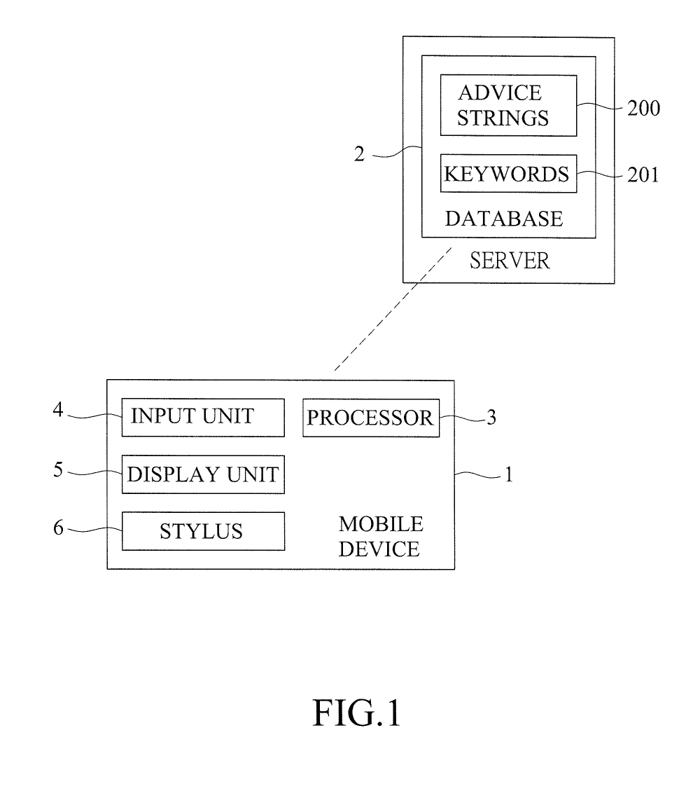

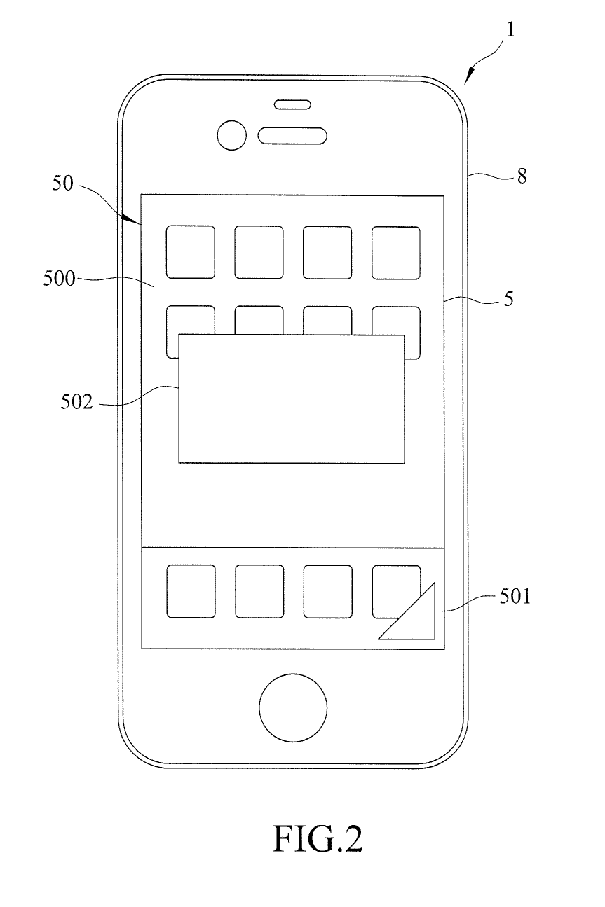

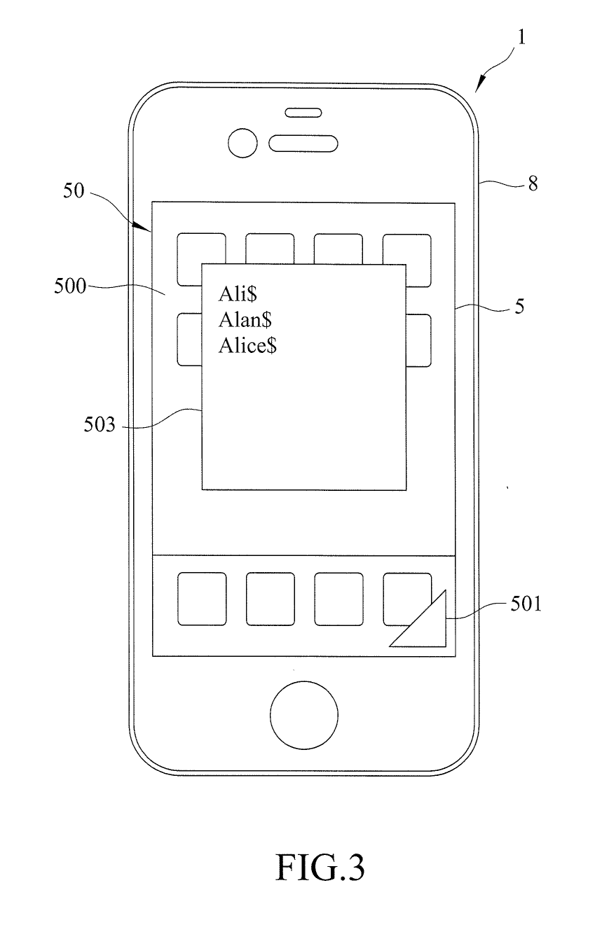

FIGS. 1, 2, and 3 show a first embodiment of a system for executing actions according to the present invention. The system includes a database 2 and a mobile device 1. In this embodiment, the database 2 resides in a remote server and is established with a plurality of reference strings (a plurality of advice strings 200 and keywords 201) and correspondence of each of the reference strings to at least one predefined action.

In this embodiment, the mobile device 1 communicates with the database 2 through a mobile network. The mobile device 1 includes a case 8, a processor 3, a stylus 6, a display unit 5, and an input unit 4.

The processor 3 is disposed in the case 8 of the mobile device 1.

The stylus 6 is disposed at a stylus indentation (not shown) formed on a surface of the case 8 of the mobile device 1.

The display unit 5 is disposed at a surface of the case 8, is electrically coupled with the processor 3, and displays a user interface 50. The user interface 50 has a desktop 500, an input element 502 for receiving input from a user, a list element 503 for displaying a string set, and a trigger element 501 persistently displayed on the desktop 500 and located on a topmost layer of the user interface 50. When the trigger element 501 is triggered by a user's touch, the processor 3 configures the display unit 5 to render the input element 502 visible to the user at the topmost layer of the user interface 50. In this embodiment, the display unit 5 is a touch control panel of the mobile device.

The input unit 4 is electrically connected with the processor 3 and is configured to receive an input from the user. In this embodiment, the input is a handwriting text input, which is detected using a touch sensitive layer of the touch control panel and recognized using a handwriting recognition software executed by the processor 3. The input can also be a voice input, and the input unit 4 includes a microphone and software for converting the voice input to a to-be-compared string. The processor 3 then compares the to-be-compared string with the reference strings in the database 2.

The user triggers by touching the trigger element 501 at a bottom right corner of the user interface 50 to render the input element 502 visible to the user at the topmost layer of the user interface 50. The user may input a handwriting text input by handwriting in the input element 502. The handwriting text input is then converted by the input unit 4 into a to-be-compared string having at least a character. The processor 3 searches the database 2 to find a string set of one or more of the reference strings that matches the to-be-compared string.

The following two scenarios are provided for illustrative purposes: In the first scenario, when the processor 3 determines that the to-be-compared string is identical with one of the keywords 201 in the database 2, the processor 3 then executes the predefined action corresponding to the keyword 201. For instance, “Santa Monica Boulevard” is one of the keywords 201 in the database 2, and the predefined action corresponding to “Santa Monica Boulevard” is performing a search in Google Maps for “Santa Monica Boulevard”. Thus, when the user inputs “Santa Monica Boulevard”, the processor 3 determines that the to-be-compared string is identical with the keyword 201 “Santa Monica Boulevard”, the processor 3 launches Google Maps using “Santa Monica Boulevard” as a search criterion. In this example, the keyword 201 “Santa Monica Boulevard” relates to a road or a place of interest, and therefore the predefined action corresponding to such keyword 201 is launching Google Maps using the keyword 201 as a search criterion.

In the second scenario, the to-be-compared string further includes a non-alphanumeric, non-numeric symbol, such as “@”, “$”, “%”, “#”, “*”, “!”, or even characters from other languages including Chinese. In this embodiment, “@” corresponds to a predefined action “launch an email App”, “$” corresponds to a predefined action “call the contact”, “%” corresponds to a predefined action “launch Google search and perform search”, “#” corresponds to a predefined action “search in Ebay”, “*” corresponds to a predefined action “search in Youtube” , and “!” corresponds to a predefined action “search in google map”. Therefore, when the user inputs “Al$” in the input element 502, the processor 3 first determines that the to-be-compared string includes a non-alphanumeric character, non-numeric symbol, and then searches the database 2 to find a string set of one or more of the reference strings that matches the to-be-compared string including the non-alphanumeric character, non-numeric symbol. The string set including “Ali$”, “Alan$” and “Alice$” is then displayed in a list element 503 on the display unit 5. When “Alice$” is selected, the processor 3 executes the predefined action corresponding to “Alice$”, i.e., calling Alice on the mobile device. The position of the non-alphanumeric, non-numeric symbol is not limited in the to-be-compared string, that is, “$Alice” is also acceptable. Alternatively, the user may input “coco ” in the input element 502. Since the database 2 may store the reference string of “coco lee(youtube)”, “coco lee(google search)”, “coco lee(ebay shop)”, “coco (contact)”,“coco road(google map)”,they are displayed in a list element 503. When the user selects “coco lee(ebay shop)”, the processor 3 launches ebay shop and searches for “coco lee”.

In summary, where the user inputs “co”, the processor 3 searches the database 2 and display the list element 503 that includes the reference strings “coffee”, “company”, “coco lee%”, “coco lee*”, “coco lee#”, “colin$”, colin@gmail.com, “coffee game(run app)”, “coco road!”, “coco lee(youtube)”,“coco lee(google search)” , “coco lee(ebay shop)”, “coco(contact)”, “coco road(google map)”from the database 2. If the user selects “coffee” or “company”, the processor 3 launches Google Maps and performs search. If the user selects “coco lee*”, the processor 3 launches Youtube and searches for “coco lee” therein. If the user selects “coffee game(run app)”, the processor 3 may launch an App named coffee game installed in the mobile device.

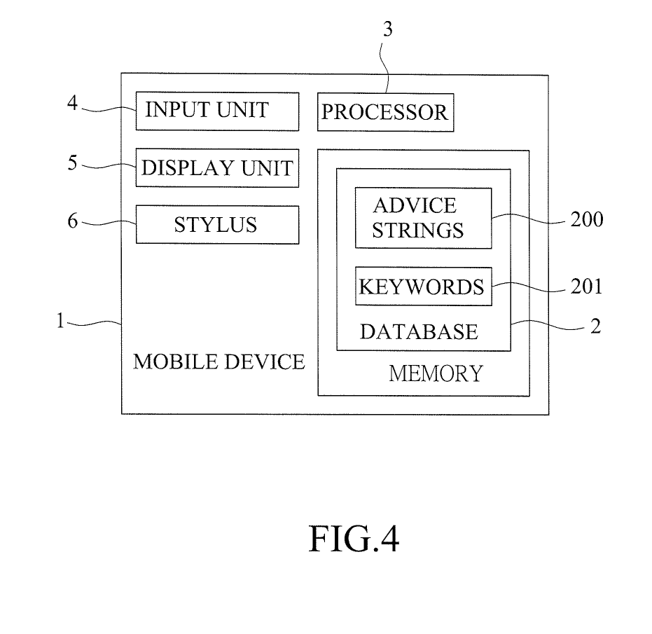

Referring to FIG. 4, a second embodiment of the present invention differs from the first embodiment in that: the mobile device 1 further includes a memory that is electrically coupled with the processor 3 and that has the database 2 residing therein. Therefore, the processor 3 of the mobile device 1 can access the database 2 without having to connect to a network.

Additionally, the stylus 6 may be electrically coupled with the processor 3. When the stylus 6 is extracted from the mobile device 1, the input element 502 for receiving user input is rendered visible to the user on the topmost layer of the user interface 50 displayed by the display unit 5.

Alternatively, the input unit 4 further includes a touch sensitive layer, and the stylus 6 is detectable by the touch sensitive layer. When the touch sensitive layer detects close proximity of the stylus 6 to the user interface 50, the input element 502 for receiving user input is rendered visible to the user on the topmost layer of the user interface 50 displayed by the display unit 5.

In summary, the system for executing actions includes: the database 2 established with a plurality of reference strings (advice strings 200 and the keywords 201) and correspondence of each of the reference strings to at least one predefined action, the input unit 4 for inputting a to-be-compared string, and the processor 3 for searching the database 2 to find a string set of one or more of the reference strings that matches the to-be-compared string, and executing the at least one predefined action corresponding to the one or more of the reference strings of the string set found by the processor 3. By such virtue, the user can conveniently execute a desired App or perform a predefined action by simply inputting a handwriting, voice, etc.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A system for executing actions, the system comprising:
a database established with a plurality of reference strings and correspondence of each of the reference strings to at least one predefined action; and
a mobile device communicatively coupled with the database, the mobile device including an input unit for inputting a to-be-compared string, and a processor electrically coupled with the input unit;
wherein the processor is configured to
search the database to find a string set of one or more of the reference strings that matches the to-be-compared string, and
execute the at least one predefined action corresponding to the one or more of the reference strings of the string set found by the processor.

2. The system as claimed in claim 1, wherein at least one of the reference strings is a keyword, and the at least one predefined action that is executed by the processor corresponds to one of the reference strings that is a keyword and that is identical to the to-be-compared string.

3. The system as claimed in claim 1, wherein the to-be-compared string includes a non-alphanumeric, non-numeric symbol, and the at least one predefined action that is executed by the processor corresponds to the non-alphanumeric, non-numeric symbol in the to-be-compared string.

4. The system as claimed in claim 1, wherein the to-be-compared string is associated with a handwriting input.

5. The system as claimed in claim 1, wherein the to-be-compared string is associated with a voice input.

6. The system as claimed in claim 1, wherein:
the mobile device further includes a display unit electrically coupled to the processor, the display unit being configured to display a user interface, the user interface including a trigger element, and an input element that is for receiving user input and that is rendered visible only after the trigger element is triggered by a user.

7. The system as claimed in claim 6, wherein the user interface further includes a list element for displaying the string set found by the processor.

8. The system as claimed in claim 1, wherein the mobile device further includes
a stylus electrically coupled with the processor and mobile device, and
a display unit electrically coupled to the processor, the display unit being configured to display a user interface, the user interface including an input element that is for receiving user input and that is rendered visible when the stylus is extracted from the mobile device.

9. The system as claimed in claim 1, wherein the input unit further includes a touch sensitive layer, and the mobile device further includes
a stylus that is detectable by the touch sensitive layer, and
a display unit electrically coupled to the processor, the display unit being configured to display the topmost layer of a user interface, the user interface including an input element that is for receiving user input and that is rendered visible when the touch sensitive layer detects close proximity of the stylus thereto.

10. The system as claimed in claim 1, wherein the mobile device further includes a memory that is electrically coupled with the processor and that has the database residing therein. 10

11. The system as claimed in claim 1, wherein the mobile device is configured to communicate with the database through a network.

12. A method for executing actions using a mobile device, the method comprising:
a) establishing, in a database, a plurality of reference strings and correspondence of each of the reference strings to at least one predefined action;
b) inputting, using the mobile device, a to-be-compared string;
c) searching, using the mobile device, the database to find a string set of one or more of the reference strings that matches the to-be-compared string; and
d) executing, using the mobile device, the at least one predefined action corresponding to the one or more of the reference strings of the string set found in step c).

13. The method as claimed in claim 12, wherein at least one of the reference strings is a keyword, and in step d), the at least one predefined action that is executed corresponds to one of the reference strings that is a keyword and that is identical to the to-be-compared string.

14. The method as claimed in claim 12, wherein the to-be-compared string includes a non-alphanumeric, non-numeric symbol, and in step d), the at least one predefined action that is executed corresponds to the non-alphanumeric, non-numeric symbol in the to-be-compared string.

15. The method as claimed in claim 12, wherein step b) includes:
inputting a handwriting input, and converting the handwriting input into the to-be-compared string.

16. The method as claimed in claim 12, wherein step b) includes:
inputting a voice input, and converting the voice input into the to-be-compared string.

17. The method as claimed in claim 12, wherein inputting of the to-be-compared string in step b) is enabled only after a trigger event has occurred.

18. The method as claimed in claim 12, wherein, in step c), the string set is displayed by the mobile device.

19. The method as claimed in claim 12, wherein the database resides in the mobile device.

20. The method as claimed in claim 12, wherein the mobile device is communicatively coupled to the database through a network.
